(19) United States
(12) Patent Application Publication
(10) Pub. No.: US 2026/0095814 A1
(43) Pub. Date: Apr. 2, 2026

(54) METHOD FOR MANAGING COMMUNICATIONS IN A COMMUNICATION NETWORK IMPLEMENTING AT LEAST ONE MOBILE INTERMEDIATE DEVICE, AND CORRESPONDING SYSTEM AND COMPUTER PROGRAM

(71) Applicant: Orange, Issy-Les-Moulineaux (FR)

(72) Inventors: Jean-Marc KELIF, Chatillon Cedex (FR); Emile STEPHAN, Chatillon Cedex (FR)

(21) Appl. No.: 18/708,974

(22) PCT Filed: Nov. 7, 2022
(86) PCT No.: PCT/EP2022/081021

§ 371 Date: Sep. 18, 2025

(30) Foreign Application Priority Data
Nov. 12, 2021 (FR) FR2112016

(51) Int. Cl. H04W 28/22; H04W 28/02; H04W 72/044

(52) U.S. Cl. CPC H04W 28/22; H04W 28/0268; H04W 72/0473

(57) ABSTRACT

A method for managing communications implementing a mobile intermediate device generating a radio beam that covers a radio cell, implementing for a data stream of the radio beam: obtaining the number of individual phases each associated with a target rate in the stream for transmissions from the mobile intermediate device to the radio cell: detecting a start of a connection of a user device present in the radio cell to a data server via the mobile intermediate device; if an individual phase is available for the stream: transmitting connection start data from the data server between the mobile intermediate device and the user device at the target rate of the individual phase until a stop criterion; if no individual phase is available for the stream: transmitting connection start data from the data server between the mobile intermediate device and the user device at a rate lower than the target rate.

### 1. FIELD OF THE INVENTION

The field of the invention is that of telecommunications.

More specifically, the invention relates to downlink communications, between a mobile intermediate device (for example a satellite, an airplane, a balloon, a drone, a high-altitude platform station HIBS, etc. and at least one user equipment (or UE for “User Equipment”, for example of the “smartphone”, laptop, connected TV type, etc.).

For example, the invention applies to satellite mobile telephone networks.

It can in particular, but not exclusively, apply to cellular systems based on an OFDMA (“Orthogonal Frequency-Division Multiple Access”) type access technology, such as LTE-A (“Long Term Evolution-Advanced”) or 5G. The invention can also be applied to satellite systems embedding a non-cellular mobile network.

### 2. PRIOR ART

Unlike previous generations, 5G proposes to divide the radio access network (RAN) into functional blocks, independent of physical network elements. The latter mainly include the following functions: a remote radio unit RU (“Remote Unit”), a distributed radio processing and scheduling unit DU (“Distribution Unit”) and a unit which is centralized towards the network core CU (“Centralized Unit”). Several variants of distribution of these functions, called “splits” have been proposed, depending on the objectives of concentrating the functions of the RAN.

It is nevertheless necessary to find a compromise between the benefits of centralization and the cost of the additional links induced by the distribution of these functions over several physical network elements, in particular the links between the DU and RU functions. Indeed, each split has a rate and latency constraint.

[FIG. 1] presents a family of “splits” called intra-physical layer known from the prior art (variants 8, 7.1, 7.2 and 7.3), where CN corresponds to the Core Network, BH to the connection between the core network and the CU function (“Backhaul”), MH the connection between the CU and DU functions s (“Midhaul”) and FH the connection between the DU and RU units (“Fronthaul”). According to this family, coding ENC/decoding DEC, puncturing PUNCT/depuncturing DE-PUNCT operations can be implemented by the DU function. The operations of modulation MOD/demodulation DEMOD, resource element mapping RE-MAP and demapping RE-DEMAP, and IFFT/FFT transformation can be implemented by the RU function.

This family of intra-physical layer “splits” is particularly studied, thanks to the benefits of radio cooperation between cells which would reduce interference and increase user rate (beamforming, joint transmission, multi-paths, etc.).

[FIG. 2] illustrates the interfaces between the virtualized network functions CU, DU and RU.

The interface F1 between the CU and DU functions, also called HLS (“Higher Layer Split”), is specified in part by the 3GPP. The O-RAN standardization alliance has in particular defined deployment scenarios wherein the interface F1 is fully interoperable.

The interface F2 between the functions DU and RU, also called LLS (“Lower Layer Split”) or “Open FrontHaul”, is an open interface (unlike a CPRI type interface (“Common Public Radio Interface”) conventionally used between a base station and its antennas). It is also specified by the 3GGP in particular for variant 7.2. At the same time, and in particular to improve radio coverage in certain geographical areas, 5G network architectures based on the use of non-terrestrial devices for radio access (“Non Terrestrial Network”), such as satellites, airplanes or else balloons, have been proposed.

[FIG. 3] illustrates an example of satellite RAN, using two satellites SAT1 and SAT2. Each of these satellites generates at least one radio beam, also called a spot. The terrestrial geographical area covered by this radio beam corresponds to a radio cell, benefiting from radio coverage. It is therefore possible to consider that a satellite emulates a radio cell. Such a radio cell is subsequently called RaF, for emulated fixed terrestrial RAN. In particular, such a radio cell can be associated with at least one cell identifier.

According to this example, a user equipment UE can connect to a server S, for example a web server, via the radio network RAN comprising the satellite SAT1 which embeds the functions RU and DU according to the architecture illustrated, and a terrestrial station GW1 (“terrestrial gateway”) which embeds the CU function, managed for example by a network operations center NoC which brings together the mobile network operator MNO and the satellite network operator SNO. The routers between different communication networks (regional network, national network for example) between the terrestrial station GW1 and the server S are illustrated by an “X”.

Different satellite RAN architectures can be implemented:
1. “Nothing onboard”, that is to say the different functions are implemented by terrestrial devices:
a. the DU function and the RU function are co-located in the terrestrial station, and the CU function in a data center remote from the MNO,
b. the DU function and the CU function are co-located in a data center remote from the MNO, and the RU function co-located with the terrestrial station,
2. “RU onboard”: that is to say, the RU function is implemented by the satellite:
a. the DU function and the CU function are remote, and the RU function located in the satellite,
b. the DU function is co-located with the terrestrial station, the CU function is remote, and the RU function located in the satellite,
3. “RU+DU onboard”, that is to say the RU and DU functions are implemented by the satellite:
a. the RU and DU functions are located in the satellite, the CU function is remote,
b. the RU and DU functions are located in the satellite, the CU function is co-located with the terrestrial station,
4. “RU+DU+CU onboard” that is to say the RU, DU and CU functions are implemented by the satellite:
a. the RU, DU and CU functions are located in the satellite,
b. the RU, DU, CU and UPF (“User Plane Function”) functions are located in the satellite.

More generally, all or part of the virtualized functions (RU, DU, CU) of the satellite RAN can be distributed over a one or more satellites of constellation and one or more terrestrial stations. Compared to a terrestrial radio access network RAN, the satellite RAN involves at least one additional radio connection, for example of the e-CPRI type, in order to connect the satellite to the terrestrial station then to the mobile core network, or even more when the virtualized functions are distributed over several satellites, with the use of ISL (for “Inter Satellite Link”) links between satellites.

Regardless of the configuration chosen, the distance between these virtualized functions (and consequently latency) must be minimized to meet the deadlines established for 5G. In particular, the latency between the RU function and the DU function must be less than one millisecond. In other words, when the DU function is also spatially localized (like the RU function), the system is less sensitive to the latency between the satellite and the ground station at least with regard to mobile radio processing.

Likewise, the CU function can also be placed in the satellite constellation, in the terrestrial station or even in a device of a remote data center.

It is also noted that the capacity of a satellite to emulate a terrestrial 5G cell is limited. Indeed, due to the distance between the satellite and the user equipment (for example 500 km for a satellite RAN instead of 5 km for a terrestrial RAN) and/or the angle of the radio beam emulating the radio cell, the size of the emulated cell is very large (for example 50 km in diameter for a RaF radio cell emulated by a satellite RAN instead of 5 km in diameter for a terrestrial cell associated with a terrestrial antenna).

However, certain applications, for example commercial Web applications, require downloading and processing a large volume of data when initializing the connection between the user equipment and the data server. In the same way, the exchange of certificates (for example during the “handshake” of TLS or QUIC protocols) requires a significant rate when initializing the connection.

There is therefore a need to provide a minimum rate to user equipments at the start of a connection, particularly when they are present in a cell emulated by a satellite RAN, or more generally emulated by a mobile intermediate device (that is to say distinct from a terrestrial fixed station) between the user equipment and a data server.

### 3. DESCRIPTION OF THE INVENTION

The invention proposes a solution which does not have all the disadvantages of the prior art, in the form of a method for managing communications in a communication network implementing at least one mobile intermediate device generating at least one radio beam that covers a terrestrial geographical area, referred to as a radio cell.

According to the invention, such a method implements the following steps, for a data stream of said at least one radio beam:
obtaining the number of individual phases, each associated with a target rate in said stream, for transmissions from said mobile intermediate device to said radio cell,
detecting the start of a connection of a first user equipment, present in said radio cell, to a first data server, via said mobile intermediate device,
if an individual phase is available for said stream: transmitting connection start data from said first data server, between said mobile intermediate device and said first user equipment, at the target rate of the individual phase, until a stop criterion,
if no individual phase is available for said stream: transmitting connection start data from said first data server, between said mobile intermediate device and said first user equipment, at a rate lower than said target rate.

Individual phase here means a set of radio resources of the data stream of the radio beam, used for transmissions between the mobile intermediate device and the radio cell, allowing to achieve a target rate. More generally, if the stream has N individual phases (N≥1), this means that it has radio resources available for transmissions between the mobile intermediate device and the radio cell allowing to achieve N target rates. For example, two users present in the radio cell can simultaneously receive the data stream carrying on the one hand connection start data at a first target rate coming from the first data server, and on the other hand data connection start at a second target rate coming from a second data server. Target rates may be different.

The invention thus proposes to estimate the capacity of a radio cell emulated by a radio beam, that is to say the number of user equipments capable of simultaneously receiving data with a target rate, corresponding to the number of individual phases of the data stream. In this way, with each new connection of a user equipment, it is possible to check if an individual phase is available, and if this is the case, to transmit the connection start data on the individual phase of the stream, that is to say with the target rate of the individual phase.

The proposed solution thus allows, according to at least one embodiment, to improve the quality of the user experience by accelerating the start of connections.

The remainder of the radio bandwidth, not used by the individual phase(s), can be used by the connections other of user equipments, in particular for the transmission of connection “tracking” data.

The proposed solution thus allows, according to at least one embodiment, to use the entire radio bandwidth efficiently.

For example, when a user equipment connects to a Web application, it is possible to provide from the start of the connection a target rate A of approximately 8 Mbps (that is to say a volume Vᵢ of 2 Megabytes of data for a duration Tᵢ of 2 seconds) in order to support interactions at a high enough pace to maintain user attention and confidence.

For the rest of the connection, the necessary rate depends on the uses and activity of the user. It is often less given the reuse of data downloaded at the start of connections by the Web application (CSS, Javascript libraries, cached images, etc.), and the data processing time (for example the concentration of the user's attention on the current page). Thus, data transmission between the mobile intermediate device and the user equipment can be carried out at the target rate of the individual phase until a stop criterion, then at a rate lower than the target rate.

In particular, these different steps can be implemented by the same device (for example a device managed by the operator of the intermediate device or a device managed by the operator of the user equipment). Alternatively, due to the virtualization of certain functions, these steps can be implemented by different devices (for example the steps of obtaining the number of individual phases and detecting the start of a connection can be implemented by at least one device managed by the operator of the user equipment, and the transmission steps by at least one device managed by the operator of the intermediate device).

According to a particular embodiment, the number of individual phases of the stream of the radio beam is defined from at least one parameter belonging to the group comprising:
said target rate Dᵢ,
an emission power P of said mobile intermediate device,
a propagation factor K between said mobile intermediate device and said radio cell, or at least one user equipment present in said radio cell,
a bandwidth W of said mobile intermediate device,
an opening angle of the emission antenna α of said mobile intermediate device,
a distance d between said mobile intermediate device and said radio cell, or at least one user equipment present in said radio cell,
a number of interfering radio beams NB between said mobile intermediate device and at least one other radio cell,
a thermal noise Nth,
the variance, or standard deviation, of the shadowing effect σ,
a probability of non-coverage Pout,

The capacity of a radio cell therefore depends on the features of the radio beam generated by the intermediate device.

In particular, such intermediate device is mobile, that is to say distinct from a fixed terrestrial station. This is for example a terrestrial device or a non-terrestrial device, such as a satellite, an airplane, a balloon, a drone, a HIBS, etc.

Such intermediate device is also called access device, in that it can connect directly to a user equipment (that is to say without passing through a fixed terrestrial antenna).

According to a particular embodiment, the number of individual phases of the stream is equal to the entire part of the capacity C of the radio beam generated by the mobile intermediate device:

$$C = \frac{W}{D} {Log}_{2} ( 1 + \frac{1}{{10}^{\frac{k}{10}} + {N}_{B}} )$$

With:

$$b = σ {Q}^{- 1} ( {P}_{out} ) + m \\ Q ( u ) = \frac{1}{2} erfc ( \frac{u}{\sqrt{2}} ) \\ m = 10 {log}_{10} ( \frac{{N}_{th}}{{KPd}^{2}} ) .$$

The decimal part of the capacity C corresponds to the remaining rate for transmissions outside the individual phase(s), called “continuation”.

The solution proposed according to this embodiment thus allows to simply determine the distribution of the radio resources of the stream, between the individual phase(s) and the rest of the stream. The distribution according to this embodiment is done by an integer division and a modulo.

For example, the stop criterion of a transmission at the target rate of an individual phase belongs to the group comprising:
a given period Tᵢ (for example of the order of 2 to 4 seconds),
a given volume Vᵢ (for example of the order of 2 to 4 megabytes),
an end of connection of said first user equipment with said first data server,
a detection of the start of a connection of a second user equipment, present in said radio cell, to a second data server with priority in relation to said first data server.

Thus, it is possible to release an individual phase of the stream after the start of the connection, since the “continuation of connection” generally requires a rate lower than the “start of connection”. The release of an individual phase of the stream allows another user equipment to benefit from the target rate at the start of the connection (or the first user equipment to benefit from the target rate at the start of connection for a new connection).

Thus, according to the proposed solution, “established” connections (also called “connection continuation”) do not capture all the radio bandwidth, and radio resources remain available for new connections.

This point is important because congestion controls on end-to-end connections are becoming increasingly aggressive and preempting maximum bandwidth at the expense of new connections.

According to a particular embodiment, the stop criterion of a transmission at the target rate of an individual phase depends on a type of service or the requested domain.

Thus, if the requested service or domain is of the video type for example, the time allocated for the individual phase may be longer, for example of the order of 4 to 10 seconds, or the volume of data allocated for the individual phase can be greater, for example of the order of 4 to 10 megabytes.

It is also possible to release an individual phase of the stream if a user equipment wishes to establish a connection with an emergency service.

According to a particular embodiment, the step of obtaining the number of individual phases is updated:
periodically, or
following a modification of a parameter of said mobile intermediate device, or
following a modification of a parameter of the radio beam generated by the mobile intermediate device, or
following a modification of said stop criterion.

The number of individual phases of the stream can dynamically, thus be adjusted in particular asynchronously. For example, the number of individual phases can be increased following a need for the 5G core network due to saturation or an incident on a terrestrial cell belonging to the terrestrial geographical area covered by the radio beam.

According to a particular embodiment, the step of detecting the start of a connection implements the detection of an exchange of data to secure the connection between said first user equipment and said first data server.

According to a particular embodiment, the detection of the start of a connection comprises:
the identification of the connection start data, from at least one marker inserted by an RRC (“Radio Resource Control”) type module into at least one data packet coming from said first data server,
the insertion of the connection start data into said individual phase available for said stream by a MAC (“Medium Access Layer”) type module,
According to this embodiment, the proposed solution thus encourages the exposure of end-to-end signaling of the connections.

According to a particular embodiment, the method implements the storage of information relating to said at least one individual phase in a management table of individual phases.

In particular, only information relating to the individual phase(s) is stored in a table. This way, the size of the stored data is small.

The invention also relates to a communication management system in a communication network implementing at least one mobile intermediate device generating at least one radio beam that covers terrestrial geographic area, referred to as a radio cell.

According to the invention, such device comprises, for a data stream of said at least one radio beam:
a module for obtaining the number of individual phases each associated with a target rate in said stream, for transmissions from said mobile intermediate device to said radio cell,
a module for detecting the start of a connection of a first user equipment, present in said radio cell, to a first data server, via said mobile intermediate device,
a module for transmitting connection start data coming from said first data server, between said mobile intermediate device and said first user equipment, at the target rate of the individual phase, until a stop criterion, activated if an individual phase is available for said stream,
a module for transmitting connection start data coming from said first data server, between said mobile intermediate device and said first user equipment, at a rate lower than said target rate, activated if no individual phase is available for said stream.

For example, such a system comprises one or more devices managed by the operator of the intermediate device (for example the satellite operator) and/or the operator of the user equipment.

These different modules can in particular be co-located or remote. For example, the modules for obtaining the number of individual phases and detecting the start of a connection belong to at least one device managed by the operator of the user equipment, and the transmission modules belong to at least one device managed by the operator of the intermediate device. According to another example, certain modules can be located on different satellites.

According to other embodiments, these different modules correspond to functional blocks, which can be co-located or remote.

The invention also relates to one or more computer programs comprising instructions for implementing a communications management method as described above when this or these programs are executed by at least one processor.

### 4. LIST OF THE FIGURES

Other features and advantages of the invention will appear more clearly upon reading the following description of a particular embodiment, given by way of a simple illustrative and non-limiting example, and the appended drawings, among which:

FIG. 1, introduced in the prior art part, illustrates the virtualization of the functions of a radio access network according to the 5G standard;

FIG. 2, also introduced in the prior art part, illustrates the interfaces between the different virtualized functions of a radio access network according to the 5G standard;

FIG. 3, also introduced in the prior art part, shows an example of radio access network architecture comprising a satellite;

FIG. 4 shows the main steps implemented by the communications management method according to a particular embodiment of the invention;

FIG. 5 shows the main steps implemented when a user equipment seeks to connect to a server, via the mobile intermediate device;

FIG. 6 illustrates an example of radio access network architecture comprising a satellite according to one embodiment of the invention;

FIG. 7 illustrates the messages exchanged between the different entities of the radio access network according to [FIG. 6];

FIG. 8 shows the simplified structure of at least one device of a communication management system according to a particular embodiment.

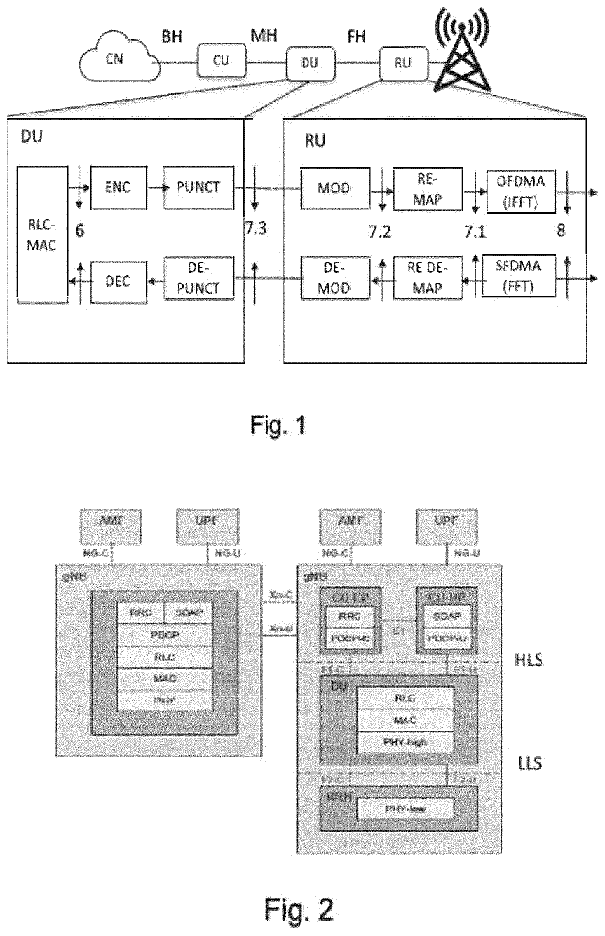

### 5. DESCRIPTION OF A PARTICULAR EMBODIMENT

### 5.1 General Principle

The invention is placed in the context of a communication network implementing a mobile intermediate transmission device (that is to say at least one radio antenna which moves, for example a satellite, an airplane, a balloon, a drone, a HIBS, etc.), and proposes a solution for improving communications via the mobile intermediate transmission device.

The general principle of the invention is based on the estimation of the number of individual phases available in the data stream of the radio beam generated by the mobile intermediate transmission device and emulating a radio cell, and on the allocation of an individual phase at the start of the connection (if an individual phase is available) allowing data transmission at a desired rate (called target rate) at the start of the connection. The proposed solution thus allows to accelerate the start of connections.

[FIG. 4] illustrates the main steps for managing communications in a communication network implementing at least one user equipment and at least one mobile intermediate device.

A mobile intermediate device generating a radio beam “illuminating” a radio cell, also called RaF is considered. The data stream of the radio beam emitted by the mobile intermediate device is received by all the user equipments present in the radio cell. Such a stream can therefore carry data intended for different user equipments, in the form of a multiplex.

During a first step 41, the number of individual phases is obtained, each phase associated with a target rate in the stream, to be used for transmissions from the mobile intermediate device to the radio cell.

During a second step 42, it is detected that a first user equipment, present in the radio cell, connects to a first data server, via the mobile intermediate device.

It is then checked (43) if an individual phase is available (that is to say if radio resources for transmission at the target rate are available).

If an individual phase is available for the stream (431): the connection start data from the first data server can be transmitted, between the mobile intermediate device and the first user equipment, at the target rate of the individual phase, until a stop criterion.

For example, the stop criterion belongs to the group comprising:
a given period Tᵢ,
a given volume Vᵢ,
an end of connection of the first user equipment with the first data server,
a detection of the start of a connection of a second user equipment, present in the radio cell, to a second data server having priority compared to said first data server,
etc.

If no individual phase is available for the stream (432): the connection start data from the first data server can be transmitted, between the mobile intermediate device and the first user equipment, at a rate lower than the target rate of the individual phase.

In this way, the radio bandwidth is used efficiently, by reserving part of the bandwidth for the start of the connection and the rest the bandwidth for the continuation of the connections.

It is thus possible to serve one or more connections at the same time, for example at a rate Dᵢ for a new connection and D′ᵢ<Dᵢ for a continuation of the connection, using the entire radio bandwidth. If X_{TOT} radio resources are considered for data transmission in the stream of the radio beam, we have

$${X}_{TOT} = {\sum }_{i = 1}^{{C}_{i}} {X}_{IND \_ i} + {X}_{RES} ,$$

with:
Cᵢ the number of individual phases,
X_{IND_i} the number of radio resources allowing to reach a target rate Dᵢ (that is to say used during the individual phase);
X_{RES} the number of remaining radio resources.

Note that the different steps presented above can be implemented by the mobile intermediate device or by a device managed by the operator of the mobile intermediate device. However, due to the virtualization of certain functions, certain steps could be implemented by a non-mobile device, for example a fixed terrestrial station.

### 5.2 Description of a Particular Embodiment

An example of implementation of the invention is presented below.

For example, it is considered that the mobile intermediate device is a satellite, managed by a satellite network operator SNO. Such a satellite is called an access satellite, in that it can connect directly to a user equipment.

The SNO, for example the OSS (“Operations Support System”), configures a satellite RAN.

For example, a satellite can generate one or more radio beams, also called spots. The features of the satellite, or of the radio beams of the satellite, can be defined using different parameters:

TABLE 1
Table of features (parameters) of the spots

| Parameter | Definition |
|---|---|
| P | spot emission power |
| K | frequency-dependent propagation factor |
| W | bandwidth (MHz) of the spot |
| D | D = Σᵢ₌₁^{N} Di, with Dᵢ the target rate (Mbits/s) |
| | of an individual phase of the stream |
| NB | number of interfering spots |
| σ | standard deviation of the shadowing (dB) |
| Nth, | thermal noise at the receiver (constant) |
| d | distance satellite - receiver |
| α | opening angle of the spot emission antenna, |
| | typically 2 to 5 degrees |

These parameters can be different for each spot generated by the satellite. In particular, certain parameters may be related to the physical features of the devices (satellite in particular), to the features desired by the mobile network operator MNO (for example a reception rate of 5 Mbps at the start of the connection for a user equipment, etc.), etc.

For example, the parameters P for emission power of the spot, W for bandwidth of the spot can be chosen by the SNO, and the parameter Dᵢ corresponding to the target rate of an individual phase can be chosen by the MNO.

Thus, for each spot, the OSS of the SNO collects the different satellite state information (main states and main propagation features) and needs (coming for example from the MNOs) and stores them in a table.

An example of a table of spot states is given below, for satellites in low orbit at around 500 km:

TABLE 2
Tables of spot states

| Spot_ID | P | K | W | D_UE | NB | Nth | d_UE |
|---|---|---|---|---|---|---|---|
| 1 | 45 dBm | 5 × 10⁻⁵ | 10 MHz | 5 Mbits/s | 6 | 10⁻¹⁰ mW | 500 km |
| 2 | 50 dBm | 5 × 10⁻⁵ | 10 MHz | 6 Mbits/s | 6 | 10⁻¹⁰ mW | 600 km |
| . . . | 50 dBm | 5 × 10⁻⁵ | 10 MHz | 5 Mbits/s | 6 | 10⁻¹⁰ mW | 700 km |
| 1000 | 55 dBm | 5 × 10⁻⁵ | 10 MHz | 5 Mbits/s | 6 | 10⁻¹⁰ mW | 600 km |

This table can in particular be exchanged between the OSS of the SNO and the satellite.

The number of individual phases of a data stream of a spot can be determined from one or more parameters defined in the tables above.

For example, the number of individual phases of the stream is equal to the integer part of the capacity C of the radio beam, such that:

$$C = \frac{W}{D} {Log}_{2} ( 1 + \frac{1}{{10}^{\frac{k}{10}} + {N}_{B}} ) \qquad ( 1 )$$

with:

$$\begin{matrix}b = σ {Q}^{- 1} ( {P}_{out} ) + m & ( 2 ) \\ Q ( u ) = \frac{1}{2} erfc ( \frac{u}{\sqrt{2}} ) & ( 3 ) \\ m = 10 {log}_{10} ( \frac{{N}_{th}}{{KPd}^{2}} ) and \\ D = {\sum }_{i = 1}^{N} {D}_{i} & ( 4 )\end{matrix}$$

In other words, considering a user using a given service with a minimum rate constraint Dᵢ (target rate), and using a bandwidth W, the proposed solution allows to establish the capacity of a spot using expression (1) above.

This capacity characterizes the number of user equipments N simultaneously receiving data with the target rate Dᵢ. In other words, this expression meets the constraints in terms of minimum rate to be achieved by each user equipment.

The capacity C of the radio beam, at a given instant, takes into account in particular:
the average value m of the power received by the user equipment,
constraints related to the environment of the user equipment on the ground, characterized by the standard deviation σ due to shadowing, at the receiver connected to a given spot. Note that the value of this last parameter can be provided by the MNO for each emulated RAN,
the probability of non-coverage Pout, or “outage” probability. This is the probability that there are not enough radio resources for transmission at the target rate at the time the user equipment connects. In other words, the user equipment has a probability Pout of not being able to connect to the spot with the target rate Dᵢ. This value can also be chosen by the MNO.

Indeed, as the spot must provide a service in a given area, with a probability of non-coverage Pout guaranteed by the operator, these constraints have an impact on the determination of the capacity of the spot.

The capacity C can also be expressed in the following form:

$$C = {C}_{i} + decimal\_part$$

Thus, the number of connections Cᵢ (that is to say individual stream phases) capable of receiving the target rate Dᵢ under a constraint Pout for a given duration is obtained.

The decimal part of the capacity C corresponds to the remaining rate for transmissions outside the individual phase(s).

The parameters, in particular the probability of non-coverage Pout, can be adjusted to increase the number of individual phases Cᵢ when necessary. The probability of non-coverage Pout can in particular be chosen from a list of possible values (10⁻¹; 0.2×10⁻¹; etc.). These different items of information can be added to the table of spot states.

| Spot_ID | Pout | Cᵢ | Comment |
|---|---|---|---|
| 1 | 10⁻¹ ; 0.2 × 10⁻¹ | 2 | Pout |
| | | | belonging to |
| | | | an interval |
| | | | allowing to |
| | | | obtain 2 |
| | | | individual |
| | | | phases if |
| | | | possible |
| 2 | 5 × 10⁻²; 2 × 10⁻² | 1 | Pout |
| | | | belonging to |
| | | | an interval |
| | | | allowing to |
| | | | obtain |
| | | | a single |
| | | | individual |
| | | | phase |
| . . . | . . . | | |
| 1000 | 10⁻¹; 0.2 × 10⁻¹ | | |

It is thus possible to distinguish several phases in the stream of the radio beam thus generated: at least one individual phase, denoted DebCo, serving the data from the start of each connection, and a phase called “common” phase, denoted ContCo, grouping together the following data from the existing connections.

As indicated previously, these different phases allow notably to use radio bandwidth efficiently and improve the quality of the user experience.

In particular, the number of individual phases can be updated:
periodically, or
following a modification of a parameter of the mobile intermediate device, or
following a modification of a parameter of the radio beam generated by the mobile intermediate device, or
following a modification of a stop criterion,
etc.

For example, periodically or asynchronously (upon an event, for example, following a need for the 5G core due to saturation or an incident on a terrestrial RAN), the OSS of the MNO estimates the number of new connections to be served by the satellite RAN, then determines or updates the different parameters from the expression (1) above and the current table of spot states, in particular:
the individual phases use in the connections (that is to say the number of connections receiving the target rate),
the number of new connections that can receive the target rate Dᵢ under constraint of Pout for a given duration, corresponding to Cᵢ,
the individual rate Dᵢ, in Mbps, for example 5 Mbps,
the duration Tᵢ of the individual rate (that is to say the duration of an individual phase), in seconds, for example 3 s,
or the individual volume Vᵢ (that is to say the volume of data transmitted in an individual phase), in MB, for example 2.5 MB,
the probability of non-coverage Pout,

These different parameters can also be added to the table of spot states.

In particular, the values of Cᵢ, Dᵢ, Tᵢ and Vᵢ can be dynamically adjusted to optimize statistical multiplexing.

These parameters can in particular be chosen according to the service or domain of the server requested. For example, a connection to a domain video.example.com may obtain twice the time Tᵢ or megabytes Vᵢ at startup compared to default values.

The OSS of the MNO or SNO can in particular update these parameters for existing connections in progress. For example, if a user equipment connects to an emergency service, the OSS can shorten (at least temporarily) the duration Tᵢ of an individual phase of an existing connection, to release the individual phase of the existing connection. In this way, the satellite can recover the individual phase for the start of a connection of the user equipment to the emergency service.

The OSS of the SNO can in particular communicate this table of spot states to the satellite.

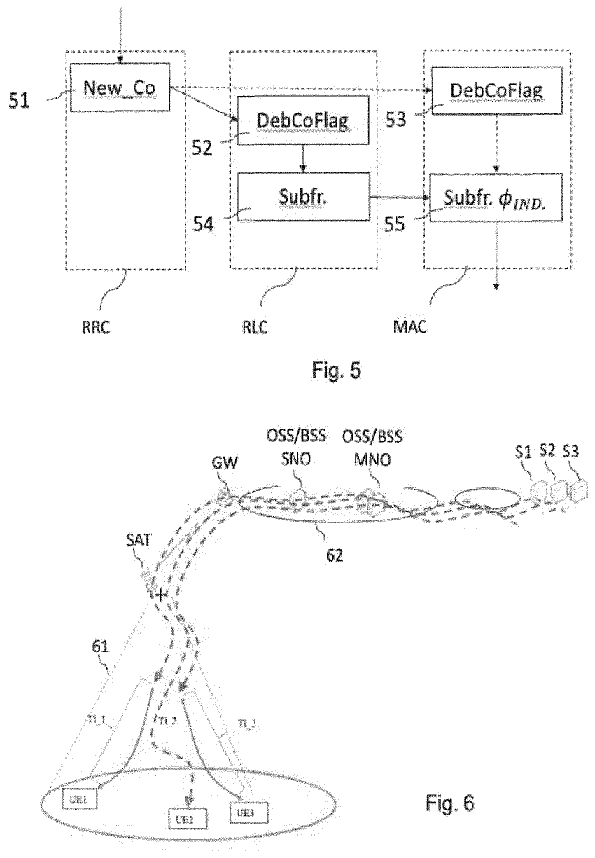

The different steps implemented when a user equipment seeks to connect to a server, via the mobile intermediate device are described below in relation to [FIG. 5]. These different steps allow to generate, at the satellite output, a data stream distributed over the entire radio cell.

During a first step 51, an RRC module seeks to detect new connections in the stream of IP packets received at the input of the satellite, based on the connection start signal, the size, the encoding, the time signature of the packets, IP packet header fields identifying the IP stream (source address, destination address, protocol, source port, destination port, etc.). Alternatively, such a step can be implemented by an RLC (“Radio Link Control”), or even MAC module.

It is considered, for example, that a user equipment present in the radio cell seeks to connect to a website monexample.com, hosted on a data server. A negotiation phase is conventionally implemented between the user equipment and the data server, via the satellite if a satellite RAN is considered.

For example, when establishing an HTTPS connection, a “TLS handshake” type process is implemented between the user equipment and the data server, via the satellite. This process includes an unencrypted phase when downloading certificates. The RRC module can thus detect the different phases of secure connections of QUIC, TLS, DTLS, EDHOC and similar protocols, and detect the start of an internet connection.

If the QUIC protocol is considered, the RRC module can identify from the size, the encoding, and/or the presence of a “ClientHello” type message the phases carrying the certificates corresponding to a first connection (QUIC 1-RTT), reconnection phases with resumption of sessions (resumption of the context of the previous connection, called QUIC 0-RTT crypto).

The RRC module can thus detect the start of a new connection.

The RRC module can also classify the received packets (as to be transmitted on an individual phase or on a common phase) based on the connection start signaling, the size, the encoding, the time signature of the packets . . . .

If the QUIC or TLS protocol is considered, the RRC module can identify from the presence of a “ClientHello” type message the phases carrying the certificates corresponding to a first connection (QUIC 1-RTT), reconnection phases with resumption of sessions (resumption of the context of the previous connection, called QUIC 0-RTT crypto) and classify the 1-RTT phases to transmit them on an individual phase and the 0-RTT phases to transmit them on a common phase.

Optionally, to prevent a user equipment from connecting multiple times with the same server to benefit each time from the individual phase which allows to reach a target rate (that is to say “charding” consisting of creating more connections to capture more bandwidth), a connection can be identified at level 3 (source address, destination address, protocol, source port, destination port, etc.).

Upon detecting a start of connection, the RRC module can transmit a start of connection flag DebCoFlag to the RLC module during a step 521, or directly to the MAC module during a step 522.

According to a first example, such a connection start flag can be intended for the RLC module. Thus, such a connection start flag can be inserted in a proprietary header or in place of an unused bit, for example a reserved bit of the QUIC protocol, for example the “spin bit”. In order to enable interoperability, such a connection start flag can alternatively be inserted in a non-proprietary message, for example the iOAM (“In-situ OAM”) header, an ECN (“Explicit Congestion Notification”) message, etc.

According to a second example, such a connection start flag is directly sent to the MAC module.

The detection of such a connection start flag allows to identify the packets of the IP streams received by the satellite which must be transmitted in the individual phase(s) leaving the satellite.

Optionally, an end of connection flag FinCoFlag can be transmitted to the RLC module or the MAC module. Alternatively, a duration DebCoDuration or volume DebCoVol information can be transmitted to the RLC module or the MAC module. It is thus possible to mark all successive packets as to be transmitted on an individual phase, or only the first and last packet concerned.

Still alternatively, the connection start flag be integer corresponding to DebCoFlag may an DebCoDuration or DebCoVol.

This end of connection flag FinCoFlag, or this information DebCoDuration or DebCoVol, can be used to determine when to stop transmission in the individual phase(s) out of the satellite,

According to the first example presented above (start of connection flag intended for the RLC module), if the RLC module receives a start of connection flag DebCoFlag, it can add it (54) in the first frames (or “subframes”) intended for the MAC module, then transmit the first frames with the connection start flag DebCoFlag.

If the connection start flag DebCoFlag is an integer corresponding to the duration DebCoDuration, it can be decremented over time (for example, if DebCoDuration is equal to 5 seconds, the first frame has the flag 5, the second frame has the flag 4, . . . , the fifth frame has the flag 1 and the sixth frame has no flag).

If the connection start flag DebCoFlag is an integer corresponding to the volume DebCoVol, it can be decremented taking into account the size of each frame.

After this period DebCoDuration, or once this volume DebCoVol has been reached, or upon detecting an end of connection type flag FinCoFlag, the RLC module no longer marks the frames (that is to say no longer inserts a flag in the frames).

In a particular embodiment, in the absence of a radio resource, the RLC module does not transmit unmarked frames to the MAC module. Alternatively, depending on the type of the RLC module (for example “Transparent Mode™)”, “Unacknowledged Mode (UM)” or “Acknowledged Mode (AM)”, as defined for example in the technical specification 3GPP TS 38.322 version 15.3.0 Release 15), the RLC module does not transmit unmarked frames to the MAC module. These frames are considered discarded or “trashed”.

Moreover, if the RLC module does not receive a connection start flag DebCoFlag, it can directly transmit the first frames to the MAC module, without marking them.

Upon receiving the frames marked according to the first example presented above (start of connection flag intended for the RLC module), the MAC module detects the start of connection flag inserted in the frames by the RLC module, and emits (55) the frames in the individual phase of the data stream.

For example, the MAC module identifies the connection start data from at least one marker/flag inserted by the RRC module into at least one data packet coming from the first data server (first frames). The MAC module can thus insert the connection start data into the individual phase of the stream of the radio beam.

If the MAC module receives on the one hand unmarked frames from the RLC module and on the other hand the start of connection flag coming from the RRC module according to the second example presented above (start of connection flag intended directly to the MAC module), it can directly emit (55) the frames identified from the connection start flag in the individual phase of the data stream.

The MAC module can emit the remaining frames in the common phase (that is to say with a rate lower than the target rate) if it has resources remaining.

According to a particular embodiment, in the absence of radio resource, the MAC module does not transmit the remaining frames. These frames are considered discarded or “trashed”.

In the embodiment described above, it is assumed that the RRC, RLC and MAC modules are co-located in the satellite. Alternatively, the RRC module and/or the RLC module can be remote, and in particular located in a fixed terrestrial device.

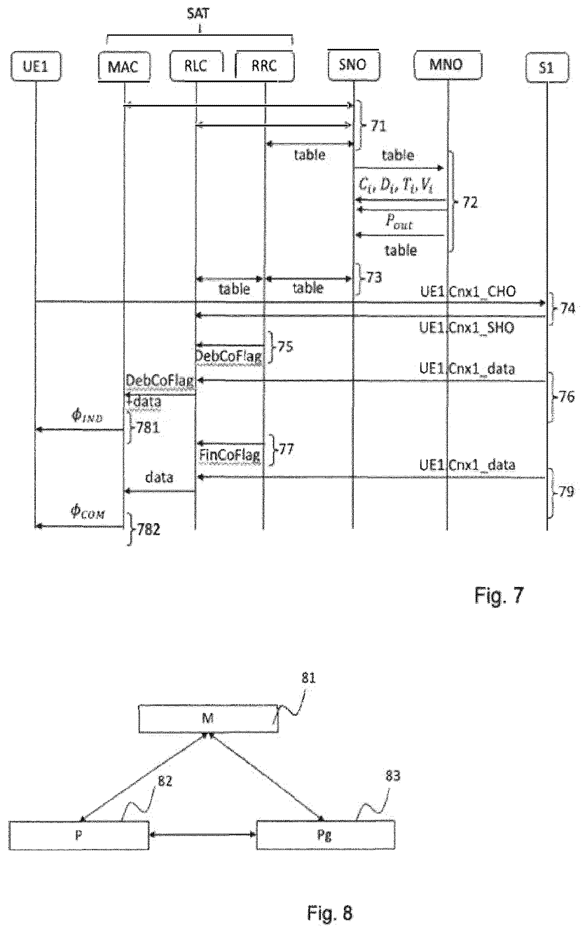

By way of example, the generation of a satellite RAN and the implementation of the proposed solution to provide a minimum rate to emergency services for example is detailed below in relation to FIGS. 6 and 7.

For example, satellite RANs can be deployed to complement or replace terrestrial RANS:
at night or during off-peak hours to stop terrestrial antennas and reduce the power consumed and the radiation emitted;
in the event of a terrestrial RAN failure;
to offload a terrestrial RAN during peak hours;
to carry out maintenance of a terrestrial RAN;
etc.

The example below develops the case of maintenance of a terrestrial RAN of an MNO. An example of use of the method by an MNO consists of using the capacity of a satellite RAN during a planned maintenance operation of a terrestrial RAN (for example change of card, restart, etc.). This operation can be carried out at night during off-peak hours. The satellite RAN must have sufficient minimum capacity to replace the terrestrial RAN, in particular to provide rate to emergency services.

Consider the context of the network in [FIG. 6], according to which a satellite SAT generates a radio beam 61 emulating a radio cell (RaF), wherein three user equipments UE1, UE2 and UE3 are present.

The SAT satellite is connected to the terrestrial network 62 (comprising the satellite network operator SNO and the mobile network operator MNO) via a terrestrial gateway GW. The user equipments UE1, UE2 and UE3 can connect to either one of the servers S1, S2 and/or S3 via the satellite SAT.

[FIG. 7] illustrates the messages exchanged between the different entities, according to one embodiment of the invention.

During a first step 71, the OSS of the SNO configures the satellite SAT. For example, the OSS of the MNO transmits “bootstrapping” and configuration type messages to the different modules of the satellite SAT (RRC, RLC and MAC in particular).

For example, it is considered that the MNO wishes to carry out the maintenance of a RAN whose cell is at the geographical position Pgeo. The 5G core of this MNO requires the creation of a RaF RaF1 (61) whose features are described by an entry in a table of spot states, such as table 2 presented above.

For example, the number of individual phases of the spot data stream is considered to be equal to 1. The RaF RaF1 therefore implements a single individual phase associated with a target rate. The rate unused by the individual phase of the data stream is used by a phase called common phase.

The SNO can thus generate the RaF1 in the satellite with these values.

The SNO can also create a management table of individual phases, allowing to track the individual phase(s) of the radio beam data stream of the RaF1. Such a management table can also be provided in the table of spot states.

During a following step 72, called the “control loop”, the MNO collects the various satellite states and needs information (for example Dᵢ, Tᵢ, Vᵢ, Pₒᵤₜ, etc.) and transmits it to the SNO. The SNO can in particular determine the capacity of the RaF RaF1 from this information.

For example, the OSS/BSS of the 5G core network (MNO) estimates the number of new connections to be served by the satellite RAN then using the analytical processing to calculate the capacity presented above, and the table of spot states of the satellite and/or the management table of the individual phases (in particular informing it of the number of individual phases in use), it updates:
the number of new connections capable of receiving the target rate Dᵢ (that is to say the number of connections having an individual phase DebCo, corresponding to Cᵢ);
the individual rate Dᵢ in Mbps, for example 5 Mbps;
the duration Tᵢ of the individual rate, in seconds, for example 3 s;
or the individual volume Vᵢ, in MB, for example 2.5 MB;
the probability of non-coverage Pout.

The MNO can also complete and/or update the management table of the individual phases with these different values.

Note that the values of Dᵢ, Tᵢ, Vᵢ and Pout can be dynamically adjusted to optimize statistical multiplexing. This is a range of adjustment of each parameter relative to the nominal value. For example, the step of estimating the number of new connections to be served by the satellite RAN generates five scenarios using analytical processing by acting on the values of Dᵢ, Tᵢ, Vᵢ and Pout by varying their values, for example from 1 to 5% in steps of 1%. For example, it is possible to increase Pout, to tend towards a value of Cᵢ of 2. The algorithm can seek to get closer to the value without trying to reach it.

The satellite and the SNO can update the table of spot states/the management table with these different values (73).

The management table of the individual phases contains in particular the control information of the individual phase(s). It is used to exchange both control information and instances of individual phases.

An example of table is shown below.

The first line of values indicates the control parameters of an individual phase. The following lines describe the progress of the individual phases.

TABLE 3
Management table of the individual phases

| | | Total | | | |
|---|---|---|---|---|---|
| | | number of | | | |
| | Number of free | individual | | | |
| | individual | phases | | | |
| | phases (or | Cᵢ (or used | | | |
| Stream | instance | by an | Dᵢ | Tᵢ | Vᵢ |
| RaF1 | type) | instance) | (Mbps) | (s) | (MB) |
| Control | 1 | 1 | 5 | 3 | 3 |

At this stage the management table of the individual phases is empty.

Note that such a table for managing individual phases does not necessarily contain information on the common phase. In this way, the size of the management table remains small, and its transmission remains inexpensive. However, in order to facilitate understanding of the invention, the information on the common phase is specified in the table in the remainder of the description.

Subsequently, in order to show how the method works, it is considered that three user equipments (UE1, UE2 and UE3, as illustrated in [FIG. 6]) connect to the RaF1. As detailed below, depending on the temporal spacing of their connection, they have an individual phase or not. Thus, as illustrated in [FIG. 6], the user equipment UE1 has the individual phase of the stream for a duration Ti_1, and the user equipment UE3 has the individual phase of the stream for a duration Ti_3, which does not overlap Ti_1. On the other hand, the user equipment UE2 does not have the individual phase.

More precisely, during a step 74, the user equipment UE1 wishes to establish a connection with the server S1. For example, the UE1 sends a message of type “ClientHello” CHO (“Connection UE1.Cnx1 end to end starts: ClientHello 1 RTT phase”) to the server S1, and the server responds with a message of type “ServerHello” SHO (“Connection UE1.Cnx1 end to end signaling: ServerHello”).

As indicated previously, the RRC module can in particular identify the different phases of secure connections of the QUIC, TLS, DTLS, EDHOC and similar protocols, by detecting the presence of the initial signaling (“handshake”). In particular, the TLS handshake of an HTTPS connection (same for QUIC and DTLS and EDHOC) includes an unencrypted part in the “ClientHello” message, in particular the phase called 1-RTT phase which includes the download of certificates. For QUIC and TLS, the RRC module distinguishes from the presence of the “ClientHello” message the phases transporting the certificates (QUIC 1-RTT phase) reconnection phases with session resumption (resumption of the crypto context, called 0-RTT, of the previous connection).

The RRC module can therefore detect a new connection UE1.CNX1 in the IP stream(s) received by the satellite.

The OSS of the SNO or satellite checks if an individual phase is free for transmission of connection start data from the satellite to the user equipment UE1 by consulting the management table of the individual phases of the spot.

As the number of free individual phases is equal to 1 (see table 3), this means that an individual phase is available for the stream when the start of the connection UE1.CNX1 detected. It is therefore possible to transmit the connection start data coming from the data server S1, between the satellite SAT and the user equipment UE1, at the target rate of the individual phase (Di_1=5 Mbps), until a stop criterion (for example for a duration Ti_1=3 s).

TABLE 4
Management table of the individual phases (t =
0 s after the start of the connection UE1.CNX1)

| | | Total | | | |
|---|---|---|---|---|---|
| | | number of | | | |
| | Number of free | individual | | | |
| | individual | phases | | | |
| | phases or | Cᵢ (or used | | | |
| Stream | instance | by an | Dᵢ | Tᵢ | Vᵢ |
| RaF1 | type | instance) | (Mbps) | (s) | (MB) |
| Control | 0 | 1 | 5 | 3 | 3 |
| UE1.CNX1 | Individual | 1 | 5 | 3 | 3 |

It is assumed that the user equipment UE2 wishes to establish a connection with the server S1 or the server S2. For example, UE2 sends a “ClientHello” type message to the server S2.

The RRC module detects this new connection UE2.CNX1 in the IP streams received by the satellite, for example one second after the start of the connection UE1.CNX1.

The OSS of the SNO or the satellite checks if an individual phase is free for the transmission of connection start data from the satellite to the user equipment UE2 by consulting the management table of the individual phases of the spot.

As the number of free individual phases is equal to 0 (see table 4), this means that no individual phase is available for the stream. The connection start data coming from the server S2 are therefore transmitted from the satellite SAT to the user equipment UE2 at a rate lower than the target rate of the individual phase. In other words, packets from connection UE2.CNX1 are exchanged in the common phase of the stream.

TABLE 5
Management table of the individual phases (t =
1 s after the start of the connection UE1.CNX1)

| | | Total | | | |
|---|---|---|---|---|---|
| | | number of | | | |
| | Number of free | individual | | | |
| | individual | phases | | | |
| | phases or | Cᵢ (or used | | | |
| Stream | instance | by an | Dᵢ | Tᵢ | Vᵢ |
| RaF1 | type | instance) | (Mbps) | (s) | (MB) |
| Control | 0 | 1 | 5 | 3 | 3 |
| UE1.CNX1 | Individual | 1 | 5 | 2 | 2 |
| UE2.CNX1 | Common | 0 | 0 | 0 | 0 |

Note that as the user equipment UE2 arrived one second after the user equipment UE1, the time remaining for the connection UE1.CNX1 on the individual phase of the stream is only 2 s.

When the stop criterion for transmission on the individual phase is reached, the individual phase is released and available for another transmission.

Thus, if we place ourselves 3.5 seconds after the start of the connection UE1.CNX1 (with Ti_1=3 s), the individual phase used for the transmission of the connection start data to the user equipment UE1 is released, and the transmission of data UE1.CNX1 continues on the common phase of the stream, at a rate lower than the target rate Dᵢ;

TABLE 6
Management table of the individual phase (t =
3.5 s after the start of the connection UE1.CNX1)

| | | Total | | | |
|---|---|---|---|---|---|
| | | number of | | | |
| | Number of free | individual | | | |
| | individual | phases | | | |
| | phases or | Cᵢ (or used | | | |
| Stream | instance | by an | Dᵢ | Tᵢ | Vᵢ |
| RaF1 | type | instance) | (Mbps) | (s) | (MB) |
| Control | 1 | 1 | 5 | 3 | 3 |
| UE1.CNX1 | Common | 0 | 0 | 0 | 0 |
| UE2.CNX1 | Common | 0 | 0 | 0 | 0 |

It is now assumed that the user equipment UE3 wishes to establish a connection with the server S3. For example, UE3 sends a “ClientHello” type message to the server S3.

The RRC module detects this new connection UE3.CNX1 in the IP streams received by the satellite, for example 4 seconds after the start of the connection UE1.CNX1.

As the number of free individual phases is equal to 1 (see table 6), this means that an individual phase is available for the stream when the start of the connection UE3.CNX1 is detected. It is therefore possible to transmit the connection start data coming from the data server S3, between the satellite SAT and the user equipment UE3, at the target rate of the individual phase (Di_1=5 Mbps), until a stop criterion (for example for a duration Ti_3=3 s).

TABLE 7
Management table of the individual phases (t =
4 s after the start of the connection UE1.CNX1)

| | | Total | | | |
|---|---|---|---|---|---|
| | | number of | | | |
| | Number of free | individual | | | |
| | individual | phases | | | |
| | phases or | Cᵢ (or used | | | |
| Stream | instance | by an | Dᵢ | Tᵢ | Vᵢ |
| RaF1 | type | instance) | (Mbps) | (s) | (MB) |
| Control | 0 | 1 | 5 | 3 | 3 |
| UE1.CNX1 | Common | 0 | 0 | 0 | 0 |
| UE2.CNX1 | Common | 0 | 0 | 0 | 0 |
| UE3.CNX1 | Individual | 1 | 5 | 3 | 3 |

The RRC module can in particular send an individual connection start signal DebCoFlag to the RLC module, or directly to the MAC module, in step 75. As indicated previously, such a signal, also called connection start flag, can be transported in different ways:
in a proprietary header,
in an unused bit, for example one of the reserved bits of the “spin-bit” of the QUIC protocol,
in a non-proprietary header, for example iOAM, ECN, etc., to increase interoperability,
etc.

The choice of signal transport depends in particular on the location of the RLC, RRC and MAC blocks, which depends on the “split” chosen and/or the manufacturers of these blocks. For example, in the case of split eCPRI A or B (3GPP option 1 or 2) and an implementation of the MAC block and the RRC block by different manufacturers, this signal is preferentially transported in a predetermined manner between these blocks.

In a step 76, such a connection start signal is for example added by the RLC module in the first frames of the packets carrying the connection start data received from the server s1 (UE1.Cnx1 data).

Optionally, an end of connection flag FinCoFlag can be transmitted (77) to the RLC module or to the MAC module. For example, the connection start flag DebCoFlag and the connection end flag FinCoFlag are transmitted in separate signals, and mark only the first and last packet carrying the connection start data received from the server S1. These signals can be sent directly to the MAC module.

Alternatively, duration DebCoDuration or volume DebCoVol information can be transmitted to the RLC module or MAC module. The duration information the DebCoDuration corresponds in particular to the duration Tᵢ of an individual phase as defined in the management table of the individual phases. The volume information DebCoVol corresponds in particular to a volume Vᵢ of data to be transmitted in an individual phase as defined in the management table of the individual phases. For example, the connection start flag DebCoFlag can be an integer corresponding to the duration information DebCoDuration and therefore decremented over time. Alternatively, the connection start flag DebCoFlag corresponds to the volume information DebCoVol and therefore decremented with the size of each frame of the accelerated packets.

Upon receiving the frames, the MAC module checks for the presence of a connection start signal DebCoFlag. If a connection start signal DebCoFlag is detected, it outputs the corresponding data in the individual phase of the spot stream (781). Otherwise, it emits the frames in the common phase of the spot stream, if it has radio resources in emission. Otherwise, the frames can be stored in (“buffer”) memory or “trashed” by the MAC module.

After the period DebCoDuration or the volume DebCoVol, or upon receiving an end of connection signal FinCoFlag, the RLC module no longer marks the frames (79). The MAC module therefore emits the frames carrying “connection continuation” data in the common phase of the spot stream (782), if it has radio resources in emission. Otherwise, the frames can be put in (“buffer”) memory or trashed by the MAC module.

Alternatively, the RLC module can store or “trash” the unmarked frames depending on the type of RLC module (Transparent™ (TM), Unacknowledged Mode (UM) or Acknowledged Mode (AM)).

If the user equipment UE1 subsequently reconnects to the same server S1, the 0-RTT phase of the QUIC protocol is implemented (UE1.Cnx2 end to end starts: ClientHello 0-RTT phase”). In this case, the MAC module can directly emit the frames carrying data received from the server S1 in the common phase of the spot stream.

### 5.3 Variants

Examples wherein the mobile intermediate device is a satellite have been described above. Other mobile access devices can of course be used, for example an aircraft, a balloon, a drone, a HIBS, etc.

Likewise, an implementation of the invention has been described when the RRC, RLC and MAC modules are co-located in the mobile intermediate device. Alternatively, depending on the “split” chosen, certain modules can be located remotely. In this case, the different signals exchanged (start and/or end of connection flag, tables, etc.) must have a format compatible with the different modules in order to be processed,

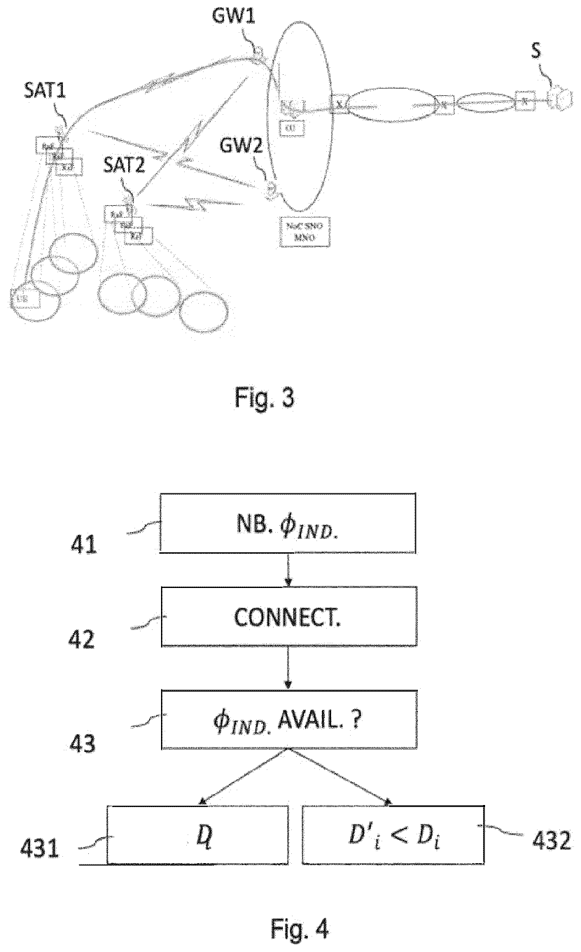

More generally, the invention can be implemented in the different architectures described in relation to [FIG. 3] (“Nothing on board”, “RU onboard”, “RU+DU onboard”, “RU+DU+CU onboard”).

An example was also presented where only one individual phase is available. In other embodiments, multiple individual phases may be available.

Returning to the example described above in relation to FIGS. 6 and 7, some variants are presented below.

According to a particular embodiment, the OSS of the MNO can update certain parameters, in particular for existing connections in progress on the individual phase.

For example, if the capacity calculation algorithm presented above proposes to shorten the duration Tᵢ of an individual phase to respond to the arrival of several new user equipments in the radio cell, in addition to UE1, then the duration T_{i_1} of the current connection UE1.CNX1 can be reduced, for example by 58, to accept the connection UE2.CNX2 a little earlier in the individual phase.

According to another example, it is possible to give priority to a request to create a UE2.CNX2 connection from an emergency service. In this case, the duration of the current connection UE1.CNX1 can be forced by the OSS of the MNO or SNO, for example to 95%, to accelerate the transition to the common phase of the transmission, in order to immediately accept the connection UE2.CNX2 to the emergency service in the individual phase.

These different examples illustrate that the parameters can be chosen or updated taking into account the service or domain of the requested server. For example, a connection to a domain video.example.com can obtain twice the time Tᵢ or megabytes Vᵢ at startup.

This case applies in particular to connections displaying their application type (such as IETF APN BoF, MASQUE WG) or in the case of cooperation between one of the BSSs and a CDN (“Content Delivery Network”) wishing to accelerate a service.

Moreover, as indicated above, in the simplest implementation, the RRC module can classify the 1-RTT phases to transmit the corresponding data on an individual phase of the stream, and the 0-RTT phases to transmit them on a common phase.

In a more advanced mode, the initial phases of connections QUIC 0-RTT can also be transmitted on an individual phase of the stream if such an individual phase is available. This individual phase can have different parameters (in particular Dᵢ, Vᵢ and/or Tᵢ), for example with a quicker switchover to the common phase (Tᵢ=2 s for example). This reduction takes into account the lower need for data at the start of reconnection due to the presence of application data in the cache of the user equipment.

In another embodiment, the fields of the CN (“Common Name”) or SAN (“Subject Alternative Name”) certificate can be used by the RRC module or one of the BSSs to identify a CDN partner, a type of service or a domain name, and associate a custom control therewith. Optionally these parameters differ with the service or domain of the requested server.

In a first implementation, the BSS can provide these rules to the RRC module in a personalization table for the individual phases. This implementation allows the classification of the connection upon detection of the connection.

For example, in the personalization table below, a connection to a domain video.example.com obtains at startup double the time Tᵢ or megabytes Vᵢ. However, the domain foo.example.com will always be classified to be transmitted in the common phase.

In addition, connections coming from the subnet IP 192.168.1.0/24 or from the domain samu.example.com preempt current connections on the individual phase, without taking resources from the common phase, with infinite duration and unlimited volume.

TABLE 8
Personalization table for the individual phases

| service | Dᵢ (Mbps) | Tᵢ (s) | Vᵢ (Mo) |
|---|---|---|---|
| video.example.com | 5 | 6 | 6 |
| foo.example.com | 0 | 0 | 0 |
| source IP | 5 | 0 | 0 |
| 192.168.1.0/24 | | | |
| Source domain | 10 | 0 | 0 |
| Samu.example.com | | | |

In a second implementation, a “service” column, receiving the domain of the connection can be added to the management table of the individual phases so that OSS/BSS of the MNO applies these rules to current connections. This implementation allows the classification of current connections after reception of the management table of the individual phases.

According to this implementation, using tables 5, 6 and 7 presented above, when the RRC module detects the new connection UE2.CNX1 in the IP streams received by the satellite, for example one second after the start of the connection UE1.CNX1, we have:

TABLE 9
Management table of the individual phases after personalization, received
from RaF1 one second after the start of the connection UE1.CNX1

| | | Total | | | | |
|---|---|---|---|---|---|---|
| | | number of | | | | |
| | Number of free | individual | | | | |
| | individual | phases Cᵢ | | | | |
| Stream | phases or type | (or used by | Dᵢ | Tᵢ | Vᵢ | |
| RaF1 | of instance | an instance) | (Mbps) | (s) | (MB) | Service |
| Control | 0 | 1 | 5 | 3 | 3 | |
| UE1.CNX1 | Individual | 1 | 5 | 2 | 2 | video.example.com |
| UE2.CNX1 | common | 0 | 0 | 0 | 0 | foo.example.com |

TABLE 10
Management table of the individual phases after
personalization, emitted by TOSS/BSS to RaF1

| | | Total | | | | |
|---|---|---|---|---|---|---|
| | | number of | | | | |
| | Number of free | individual | | | | |
| | individual | phases Cᵢ | | | | |
| Stream | phases or type | (or used by | Dᵢ | Tᵢ | Vᵢ | |
| RaF1 | of instance | an instance) | (Mbps) | (s) | (MB) | Service |
| Control | 0 | 1 | 5 | 3 | 3 | |
| UE1.CNX1 | individual | 1 | 5 | 5 | 5 | video.example.com |
| UE2.CNX1 | common | 0 | 0 | 0 | 0 | foo.example.com |
| UE2.CNX1 | common | 0 | 0 | 0 | 0 | foo.example.com |

When the RRC module detects the new connection UE3.CNX1 in the IP streams received by the satellite, for example 4 seconds after the start of the connection UE1.CNX1, we have:

TABLE 7
Management table of the individual phases after personalization

| | Number of free | Total number | | | | |
|---|---|---|---|---|---|---|
| | individual | of individual | | | | |
| | phases or | phases Cᵢ | | | | |
| Stream | instance | (or used by | Dᵢ | Tᵢ | Vᵢ | |
| RaF1 | type | an instance) | (Mbps) | (s) | (MB) | service |
| Control | 0 | 1 | 5 | 3 | 3 | |
| UE1.CNX1 | individual | 1 | 5 | 1 | 1 | |
| UE2.CNX1 | common | 0 | 0 | 0 | 0 | |
| UE3.CNX1 | common | 0 | 0 | 0 | 0 | |

Note that the transmission with the first user equipment UE1.CNX1 is always in the individual phase of the spot stream. On the other hand, the transmission with the third user equipment UE3.CNX1 is in the common phase of the stream, since the number of free individual phases is always zero.

In particular, the choice of implementation of the above personalization depends on the location of the RRC block of the centralized unit CU. A location “onboard” the CU (remote from the OSS/BSS) implies the choice of a common transport mode (standardization) of the personalization table of the individual phases/management table of the individual phases after personalization.

### 5.4 Corresponding System

The simplified structure of a communication management system is finally presented according to at least one embodiment described above, comprising modules for obtaining the number of individual phases, detecting the start of a connection, and connection start data transmission.

As already indicated, these modules can be co-located within the same device (for example a device managed by the mobile operator or by the satellite operator), or remote.

According to the example illustrated in [FIG. 8], at least one device of such a system comprises at least one memory 81 comprising a buffer memory, at least one processing unit 82, equipped for example with a programmable calculation machine or a dedicated calculation machine, for example a processor P, and controlled by the computer program 83, implementing steps of the communication management method according to at least one embodiment of the invention.

Upon initialization, the code instructions of the computer program 83 are for example loaded into a RAM memory before being executed by the processor of the processing unit 82.

The processor of the processing unit 82 implements steps of the communications management method described above, according to the instructions of the computer program 83, to:
obtain a number of individual phases each associated with a target rate in said stream, to be used for transmissions from said mobile intermediate device to said radio cell,
detect the start of a connection of a first user equipment, present in said radio cell, to a first data server, via said mobile intermediate device,
transmit connection start data from said first data server, between said mobile intermediate device and said first user equipment, at the target rate of the phase, until a stop individual criterion, an if individual phase is available for said stream, or
transmit connection start data from said first data server, between said mobile intermediate device and said first user equipment, at a rate lower than said target rate, if no individual phase is available for said stream.

According to a particular embodiment, these different steps can be implemented by co-located or remote physical or software modules.

1. A method for managing communications in a communication network implementing at least one mobile intermediate device generating at least one radio beam that covers a terrestrial geographical area, referred to as a radio cell, characterized in that it implements the following steps, for a data stream of said at least one radio beam:
obtaining (41) the number of sets of radio resources of the data stream of the radio beam, used for transmissions between the mobile intermediate device and at least one first user equipment present in the radio cell, a set of radio resources allowing to achieve a target rate,
detecting (42) the start of a connection of a first user equipment, present in said radio cell, to a first data server, via said mobile intermediate device,
if a set of radio resources allowing to achieve a target rate is available for said stream: transmitting (431) connection start data coming from said first data server, between said mobile intermediate device and said first user equipment, at said target rate, until a stop criterion,
if no set of radio resources allowing to achieve a target rate is available for said stream: transmitting (432) connection start data coming from said first data server, between said mobile intermediate device and said first user equipment, at a rate lower than said target rate.

2. The method according to claim 1, characterized in that the number of sets of radio resources of said stream is defined from at least one parameter belonging to the group comprising:
said target rate Dᵢ,
an emission power P of said mobile intermediate device,
a propagation factor K between said mobile intermediate device and said radio cell, or at least one user equipment present in said radio cell,
a bandwidth W of said mobile intermediate device,
an opening angle of the emission antenna α of said mobile intermediate device,
a distance d between said mobile intermediate device and said radio cell, or at least one user equipment present in said radio cell,
a number of interfering radio beams NB between said mobile intermediate device and at least one other radio cell,
thermal noise Nth,
the variance of the shadowing effect σ,
a probability of non-coverage Pout.

3. The method according to claim 2, characterized in that the number of sets of radio resources of said stream is equal to the integer part of the capacity C of said radio beam
$$C = \frac{W}{D} {Log}_{2} ( 1 + \frac{1}{{10}^{\frac{k}{10}} + {N}_{B}} ) with : \\ b = σ {Q}^{- 1} ( {P}_{out} ) + m , \\ Q ( u ) = \frac{1}{2} erfc ( \frac{u}{\sqrt{2}} ) , \\ m = 10 {log}_{10} ( \frac{{N}_{th}}{{KPd}^{2}} ) .$$

4. The method according to any one of claims 1 to 3, characterized in that said stop criterion depends on a type of service.

5. The method according to any one of claims 1 to 4, characterized in that said stop criterion belongs to the group comprising:
a given period Tᵢ,
a given volume Vᵢ,
an end of connection of said first user equipment with said first data server,
a detection of a start of a connection of a second user equipment, present in said radio cell, to a second data server having priority compared to said first data server.

6. The method according to any one of claims 1 to 5, characterized in that said step of obtaining the number of sets of radio resources is updated:
periodically, or
following a modification of a parameter of said mobile intermediate device, or
following a modification of a parameter of said radio beam generated by said mobile intermediate device, or
following a modification of said stop criterion.

7. The method according to any one of claims 1 to 6, characterized in that said detection of the start of a connection implements the detection of an exchange of data to secure the connection between said first user equipment and said first data server.

8. The method according to any one of claims 1 to 7, characterized in that said detection of the start of a connection comprises:
the identification of said connection start data, from at least one marker inserted by an RRC type module into at least one data packet coming from said first data server,
the insertion of said connection start data into the set of radio resources available for said stream by a MAC type module.

9. The method according to any one of claims 1 to 8, characterized in that it implements the storage of information relating to said at least one set of radio resources in a management table for sets of radio resources.

10. A system for managing communications in a communication network implementing at least one mobile intermediate device generating at least one radio beam that covers a terrestrial geographical area, referred to as a radio cell, characterized in that it comprises, for a data stream of said at least one radio beam:
a module for obtaining the number of sets of radio resources from the data stream of the radio beam, used for transmissions between the mobile intermediate device and at least one first user equipment present in the radio cell, a set of radio resources allowing to achieve a target rate,
a module for detecting the start of a connection of a first user equipment, present in said radio cell, to a first data server, via said mobile intermediate device,
a module for transmitting connection start data coming from said first data server, between said mobile intermediate device and said first user equipment, at the target rate of a set of radio resources, until a stop criterion, activated if a set of radio resources is available for said stream, and
a module for transmitting connection start data coming from said first data server, between said mobile intermediate device and said first user equipment, at a rate lower than said target rate, activated if no set of radio resources is available for said stream.

11. A computer program comprising program code instructions for implementing a method according to any one of claims 1 to 9, when executed by a processor.
